(19) United States
(12) Patent Application Publication
(10) Pub. No.: US 2009/0031360 A1
(43) Pub. Date: Jan. 29, 2009

(54) METHOD AND SYSTEM FOR ENABLING A SERVICE USING A WELCOME VIDEO

(75) Inventors: Deanna R. Kidd, Long Beach, CA (US); Shandle Green, Inglewood, CA (US); Raynold M. Kahn, Los Angeles, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: The DIRECTV Group, Inc., El Segundo, CA (US)

(21) Appl. No.: 11/782,784

(22) Filed: Jul. 25, 2007

(51) Int. Cl. H04N 7/16; H04H 1/00; H04H 7/00; H04N 7/173; H04N 7/088

(52) U.S. Cl. 725/62; 455/3.02; 455/3.06; 725/100; 725/104; 725/110; 725/131; 725/139; 725/63; 725/64

(57) ABSTRACT

A communication system 10 includes a service provider 12 used to provide content to a user device 14. The user device 14 is coupled to a network. A service is selected at the user device. A welcome video is communicated from the service provider 12 to the user device 14. A confirmation signal is provided from the user device 14 to the service provider 12 in response to successfully receiving the welcome video. Access to the service is enabled at the service provider 12 in response to the confirmation signal.

### TECHNICAL FIELD

The present disclosure relates generally communicating between a service provider and a user device, and, more specifically, to enabling a service such as a video download service through a user device such as a set top box.

### BACKGROUND

The statements in this section merely provide background information related to the present disclosure and may not constitute prior art.

Consumers increasingly desire access to various types of content, including music, videos, games, and the like. To meet these needs, content providers are increasingly investigating ways to provide content in a timely manner to consumers.

Satellite distribution systems are one way in which to provide content to various consumers. Pay-per-view and regular broadcasts are available in a satellite system. In a pay-per-view system, access is provided to users for a particular program that is watched by more than one user at the same time. Recording devices in the user devices may be used to store the content for later playback.

In certain situations, a user may desire access to content not available during a regular broadcast. Providing the user with a program on an individual basis, consumes valuable satellite resources. Therefore, it may be desirable to provide other means for distributing content when needed to various customers.

### SUMMARY

The present disclosure sets forth a method for utilizing a terrestrial communication network for providing requested content to a user device. In the case of a satellite content distribution system, another network such as a broadband network may be used to provide the content to the user device or set top box. This method reduces the burden on the satellite system.

In one aspect of the disclosure, a method of accessing a service from a user device comprises coupling the user device to a network, selecting the service, communicating a welcome video from the service provider through the network to the user device in response to selecting the service, communicating a confirmation signal from the service provider in response to successfully receiving the welcome video and enabling access to their service in response to the confirmation signal.

In a further aspect of the disclosure, a method of accessing a video download service from a set top box comprises coupling the set top box to a broadband network, selecting the video download service from a user interface's screen associated with the set top box, generating a service selection signal in response to selecting, communicating the service selection signal to the service provider through the broadband network, communicating a welcome video from a service provider through the broadband network to the set top box in response to the service selection signal, communicating a confirmation signal from the set top box to the service provider in response to successfully receiving the welcome video and enabling access to the service in response to the confirmation signal.

In a further aspect of the disclosure, a communication system includes a service provider used to provide content to a user device. The user device is coupled to a network. A service is selected at the user device. A welcome video is communicated from the service provider to the user device. A confirmation signal is provided from the user device to the service provider in response to successfully receiving the welcome video. Access to the service is enabled at the service provider in response to the confirmation signal.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a block diagrammatic system view of a communication system according to the present disclosure.

FIG. 2 is a representation of a user interface on a display associated with the user device.

FIG. 3 is a screen display of a user interface for subscribing to the service.

FIG. 4 is a screen message on a display for subscribing to the service.

FIGS. 5A and 5B are a block diagrammatic view for subscribing to a service using a combination of a website and a user device.

FIG. 6 is a flowchart of a method for enabling a service using a user device.

### DETAILED DESCRIPTION

The following description is merely exemplary in nature and is not intended to limit the present disclosure, application, or uses. For purposes of clarity, the same reference numbers will be used in the drawings to identify similar elements. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical or. It should be understood that steps within a method may be executed in different order without altering the principles of the present disclosure.

While the following disclosure is made with respect to example DIRECTV® broadcast services and systems, it should be understood that many other delivery systems are readily applicable to disclosed systems and methods. Such systems include wireless terrestrial distribution systems, wired or cable distribution systems, cable television distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), Internet-based distribution systems, cellular distribution systems, power-line broadcast systems, any point-to-point and/or multicast Internet Protocol (IP) delivery network, and fiber optic networks. Further, the different functions collectively allocated among a service provider and integrated receiver/decoders (IRDs) as described below can be reallocated as desired without departing from the intended scope of the present patent.

Further, while the following disclosure is made with respect to the delivery of content (e.g., television (TV), movies, games, music videos, etc.), it should be understood that the systems and methods disclosed herein could also be used for delivery of any media content type, for example, audio, music, data files, web pages, games, etc. Additionally, throughout this disclosure reference is made to data, information, programs, movies, assets, video data, etc., however, it will be readily apparent to persons of ordinary skill in the art that these terms are substantially equivalent in reference to the example systems and/or methods disclosed herein. As used herein, the term title or program will be used to refer to, for example, a media content type such as a movie itself and not the name of the movie.

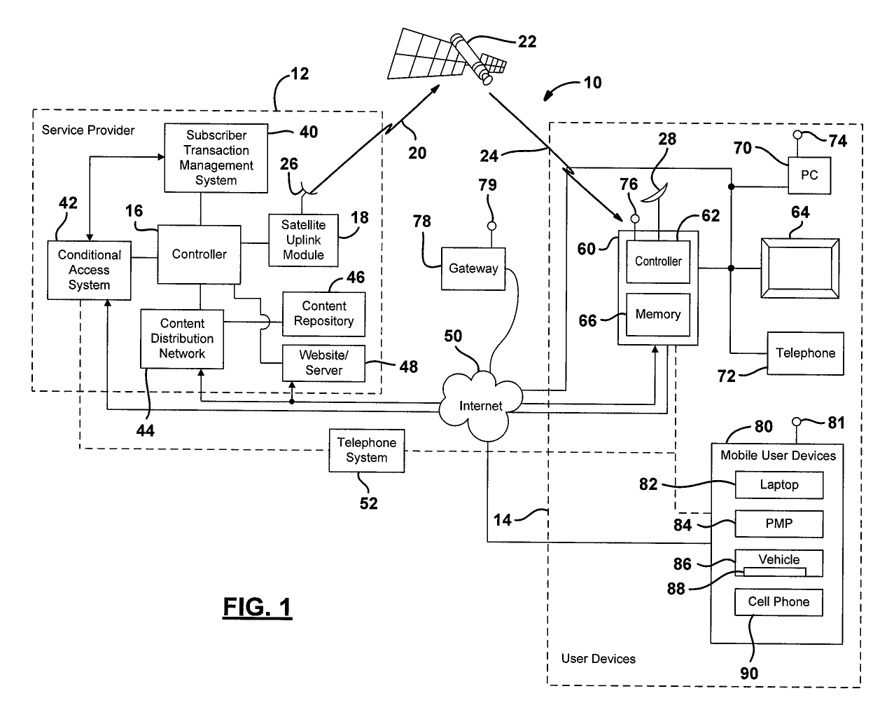

Referring now to FIG. 1, a communication system 10 includes a service provider 12 that communicates content to user devices 14. The service provider 12 may include a controller 16 that is used to control the overall operation of the system. The controller 16 and some of the associated modules and components may be referred to as a head end. A satellite uplink module 18 is used to generate and communicate uplink signals 20 to satellite 22. Satellite 22 generates downlink signals 24 to one or more user devices 14. An antenna 26 associated with the satellite uplink module 18 is used to generate the uplink signals 20. A downlink antenna 28 associated with the user device 14 is used to receive downlink signals. Various types of content or program signals and security information signals, but not limited to security information, encryption-decryption information, digital rights management information, purchase information packets (PIPs), conditional access packets (CAPs), channel or content access lists or rights may be communicated through the communication system 10. It should also be noted that various content may be encrypted based upon a control word (CW) known to the service provider and/or the various user devices. Control word packets (CWPs) may include, among other things, authorization requirements, a time stamp and an input value for computing the control word by a decryption or a cryptographic hash of the contents. The control word packets may, from time to time, be transmitted from the service provider through the satellite to the user devices.

The service provider 12 may also include a subscriber transaction management system 40. The subscriber transaction management system (STMS) 40 has the function of a billing system. The STMS 40 keeps track of various transactions and the services to which the various user devices are subscribed to. Billing information and enabling access to a system may be provided through the subscriber transaction management system.

A conditional access system 42 may also be coupled to controller 16. The conditional access system 42 generates conditional access packets that may be provided through the satellite or through other communication networks to the user devices 14. The conditional access system 42 may, for example, generate the CAPs, PIPs and CWPs described above.

A content distribution network 44 may also be coupled to controller 16. The content distribution network 44 in conjunction with a content repository 46 may be used to provide content through the satellite and through the various other networks. The content distribution network 44, although illustrated entirely within the service provider, may also be outside or partially outside the service provider 12. That is, user devices 14 may be provided access to content from various sources directly once authorized by the service provider. A pay television service may provide content to a user device directly once all the security safeguards have been met.

A website or server 48 may also be coupled to the controller 16. The website 48 may provide the user devices 14 a way in which to enable or initially subscribe to a service. The use of the various components within the service provider 12 will become evident in the description below.

The conditional access system 42, the content distribution network 44, and the website 48 may all be coupled to the Internet 50. The Internet 50 may be reached through various types of networks, including, but not limited to, a wireless network, a broadband network, a broadband wireless network, a WiFi network, a WiMax network and an optical fiber network.

A telephone system 52 may also be used to communicate between the user device 14 and the service provider 12. The telephone system 52 may include a cellular system that is for the most part wireless or a public switched telephone network (PSTN).

One example of a user device 14 includes a fixed user device such as a set top box 60. The set top box 60 may have various components such as a controller 62 that is used to control the operation of the system and generate and provide the content to the display device 64 such as a television. The set top box 60 may also be referred to as integrated receiver decoder (IRD). The set top box 60 may decode, decompress, depacketize, and demultiplex the content received from the satellite 22. Also, any content received from the Internet 50 may also be decoded, demultiplexed, decompressed and depacketized, if needed. Output drivers, contained within the controller, may be used to control the audio and visual function of the display 64.

The set top box 60 may also include a memory 66. The memory 66 may, for example, be a digital video recorder (DVR) such as a hard disk drive. The memory 66 may also be various other types of memory including flash memory. The memory 66 may be used to store content or programs received from the service provider 12 through the satellite 22 or through the Internet 50.

The user device 14 associated with the set top box 60 may also include or be associated with a personal computer 70. The personal computer 70 may be used to provide Internet access for the set top box 60 so that various content may be downloaded from the Internet 50 and from the service provider 12. More specifically, content from the content repository 46 may be provided through the content distribution network 44 through the Internet 50 and stored on the memory 66 of the set top box 60. The personal computer 70 may be used to form the network between the set top box 60 and the Internet 50. The connection between the personal computer 70 and the set top box 60 may be a wired or wireless connection. Of course, if the connection is a wireless connection, a wireless LAN and thus a wireless router may be associated or included within the personal computer 70. An antenna 74 on the PC 70 represents a potential wireless connection to antenna 76 on the set top box 60. The antenna 76 on the set top box 76 may also communicate to an outside wireless router, such as in a Wimax or WiFi system.

A gateway 78 may be used to form access to the Internet in a WiFi or WiMax system through antenna 79. A telephone 72 may also be used to communicate with the service provider 12. The telephone 72 may be used to initiate service by the user who communicates directly with an operator or a menu system at the service provider 12. Part of the information received from the satellite 22 may include a program guide that includes various selections therein. The program guide may include selections for selecting a broadband video download service. This will be further described below.

The user devices 14 may also include mobile user devices 80. The mobile user devices 80 may include the functionality described above with respect to the set top box 60 such as a controller, a memory, an antenna 81 for communicating with the satellite and communicating through the wireless network. Although one antenna 81 is shown, more than one may be used to receive the wireless network signals and the satellite signals. The antenna 81 is shown generally. The antenna 81 may be incorporated within each device. However, mobile user devices 80 may communicate wirelessly through the Internet 50, through a telephone system 52, such as a cellular system, through the Internet, a WiFi, WiMax, other type of wireless systems or more than one type of wireless system. The wireless communications may communicate content or programs as well as provide callbacks from the mobile user devices 80 to the service provider 12. The call backs may include a request for content. The call backs may also include report back of programs that have been viewed or pay-per-view programs that have been purchased. Confirmation signals may also use the Internet 50 or the telephone system 52 as will be further described below. It should also be noted that a different network may be used to communicate program content and other communications between the service provider 12 and the user devices 14 including the mobile user devices 80.

The mobile user devices 80 may include many different devices, including a laptop computer 82, a portable media player 84, a vehicle such as an automotive vehicle that includes a mobile set top box 88 and a cell phone 90. The cell phone 90 may include such devices as a personal digital assistant. It is important that all of the mobile user devices 80 include some form of wireless communication system to receive content from the service provider 12.

Referring now to FIG. 2, a display 64 having a graphical user interface 100 is illustrated. In this example, various options may be presented on the display 64 to the users. This may be obtained through a menu system. For example, the interface may be reached using a program guide. In this example, two choices are provided to the users to “select pay-per-view” or “subscribe to the broadband video service.” In this example, the subscribed to broadband video service box 102 is highlighted on the display using a bolded box outline. By selecting buttons on a remote control or on the set top box itself, the subscribed to broadband video service button may be selected. The above description also applies to a user device that is associated with a display. Each of the mobile user devices 80 may also include the display.

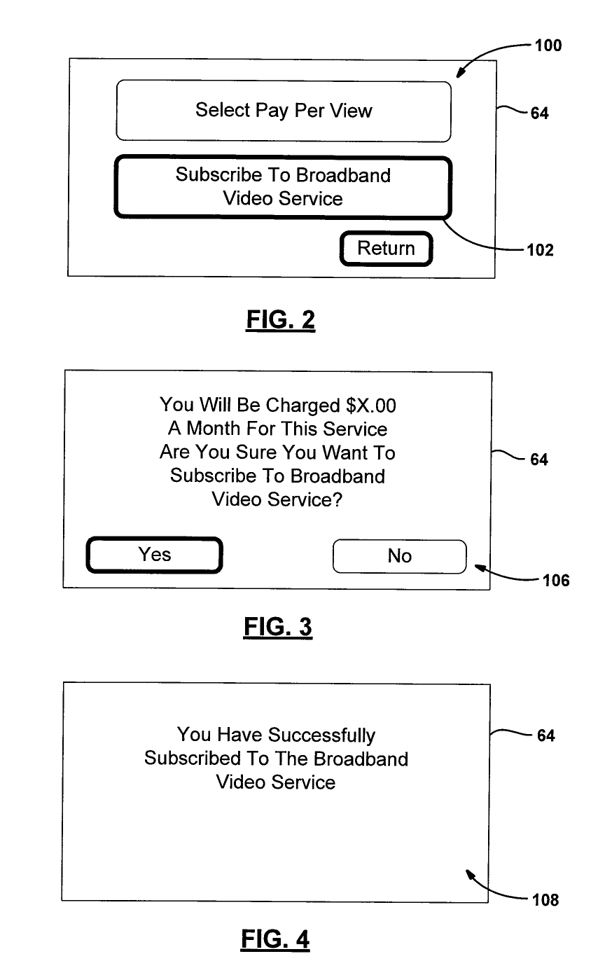

Referring now to FIG. 3, a second example of a screen display 106 may be set forth. Once a subscriber or user selects the subscribed to broadband video service button in FIG. 2, a message may be provided that the service they are about to subscribe to is a pay service and they will be charged a monetary amount for the service. FIG. 3 provides a way to provide confirmation to the user for the particular service. Therefore, a graphical user interface selection for “yes” or “no” is provided to be sure the subscriber intends to subscribe to the service.

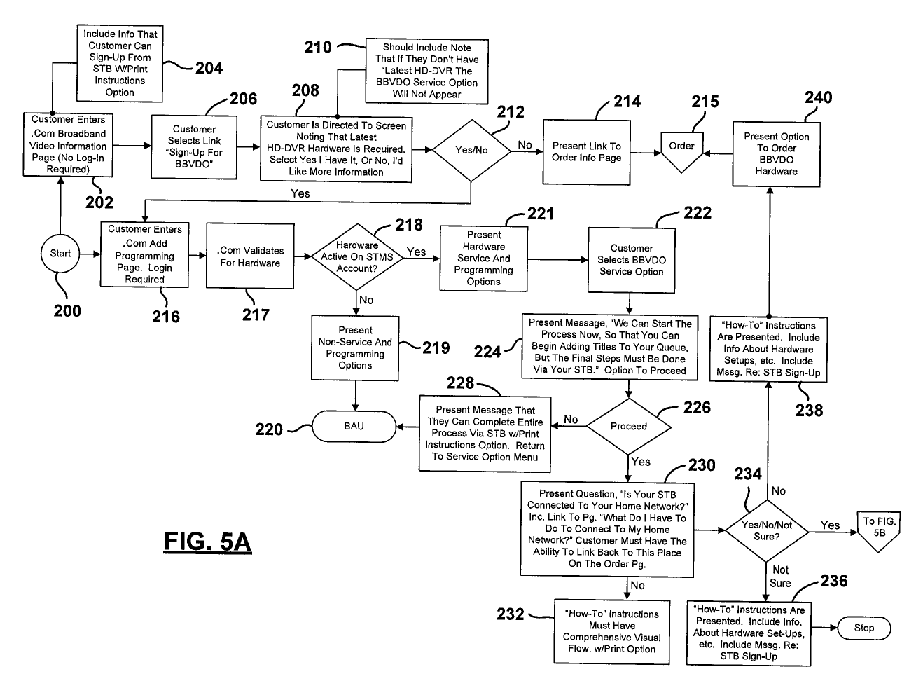

Referring now to FIG. 4, a screen display message 108 on the display 64 is displayed after a confirmation signal they are subscribed to the particular service. In this example, the broadband video service is set forth.

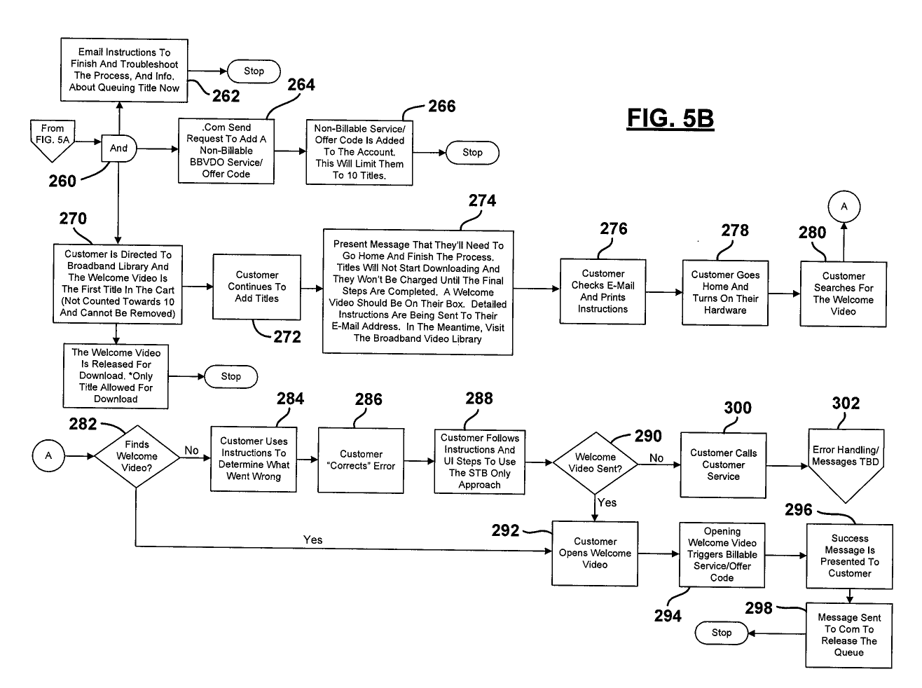

Referring now to FIGS. 5A and 5B, a first method for subscribing to the broadband video service or other type of service is illustrated. In this example, the subscription may be initiated using a dotcom website.

The system starts with the start box 200. In step 200, the customer or user chooses whether to log into the broadband video service system or not. In step 202, no login is required and, therefore, just general information is provided. Step 204 provides information that a customer can sign up from the set top box with printed instructions. In step 206, the customer selects sign up for broadband video service. In step 208, the customer must have the latest hardware able to access the service. A message may be provided in step 210 associated with step 208 that if the customer does not have the latest hardware, the option may not appear on the set top box. If the customer chooses that they do not have the proper hardware in step 212, step 214 allows the customer to select the proper hardware and order it in step 215.

Referring back to step 212, if the customer does have the proper hardware, or after step 200 the customer is directed to logon to their account. In step 216, the customer logs on to the system using a password or the like. In step 217, the customer may be asked to validate the hardware and the account information. The hardware may be validated by providing a serial number or the like. In step 218, if the hardware is not active on the account, step 219 presents a non-service and programming option to the customer. In step 220, the system performs business as usual (BAU), meaning no account status is changed.

Referring back to step 218, if the hardware is active, the customer may be presented with programming options in step 221. In step 222, the customer selects the service option from a menu presented on the website. In step 224, a message such as “we can start the process now, so that you can begin adding titles to your queue but the final steps must be done with your set top box” may be provided. An option to proceed may also be provided. In step 226, the option to proceed if answered negatively, performs step 228 in which the instructions are presented to the user that the entire process may be performed using the set top box or other user device. In step 226, if the customer chooses to proceed, step 230 is performed. In step 230, it is determined whether or not the set top box is connected to a home network. The home network may include a broadband network such as a wireless Internet connection or a wired Internet connection. If the customer does not have a connection, step 232 may be performed in which instructions may be provided to the customer so that the set top box may be connected to the network. As mentioned above, the set top box may be connected by way of a wired connection through an Ethernet port on the set top box.

In step 230, if the customer is sure or not sure he is connected, step 234 may be performed. In step 234, if the customer is not sure, step 236 is performed in which instructions are presented about hardware setups. To place the set top box or other user device within the network, a medium access control (MAC) address may be used. The MAC address may be used by some routers in addressing the components parts of the local area network. The MAC address may be assigned in this step or may be assigned in the set top box user interfaces. If the answer is a NO in step 234, instructions may be presented in step 238 about hardware setups including messaging and set top box configuration. This ensures that customers have their own broadband video-capable hardware and can use it rather than purchasing a specific device from the set top box or service provider. In step 240, the user may be presented with options to order the specific user device or set top box. Step 215 orders the user device after step 240.

Referring back to step 234, if the answer is in the affirmative, step 260 may be performed in FIG. 5B. If the answer is affirmative, step 262 may provide email instructions to finish and troubleshoot the process and information on how to queue titles. In step 260, the website may provide or request a non-billable service offer to the customer which allows the customer to add various titles to the system in step 264. In step 266, a non-billable service/offer code may be added to the account which may limit the account to 10 titles. This will provide an opportunity for the customer to visit the broadband video programming available without actual purchase.

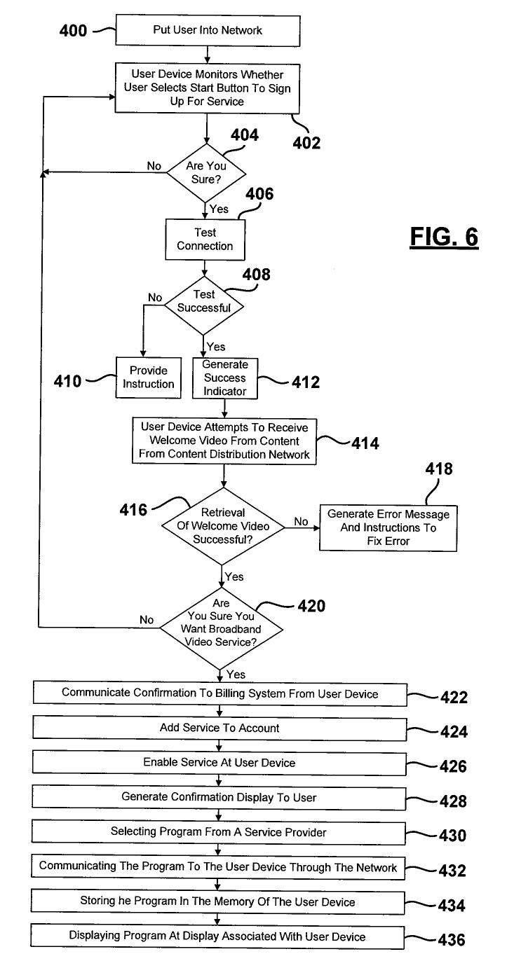

Referring back to step 260, the customer may desire to download various titles from the broadband library and the welcome video. This is performed in step 270. The welcome video may not be removed from the cart and may be provided as the first title. In step 272, the customer continues to add titles to be downloaded into their account. In step 274, the customer may be provided with a title or with screen messages to finish the process at their user device. This may take place at home using a fixed set top box. A welcome video may be downloaded to the set top box during this process so it is waiting for the customer when ready. In step 276, the customer may check the email and print the instructions emailed prior. In step 278, the customer may return home and perform the instructions by turning on the hardware. In step 280, the customer finds the video on the system. In step 282, if the welcome video is not found, step 284 is performed in which the customer uses instructions to determine an error. In step 286, the customer corrects the error and in step 288, the customer follows the instructions on the user interface to use the set top box only approach. The set top box only approach will be described in FIG. 6 below in more detail. In step 290, it is determined whether or not the welcome video has been sent. If the video has been sent in step 290 and after the affirmative in step 282, step 292 is performed. In step 292, the customer opens the welcome video. In step 294, a confirmation signal such as a billable service or offer code is communicated to the service provider. This may be communicated in a number of ways including through the various types of network such as a wireless network, a WiFi network, a WiMax network, a broadband connection, or a telephone network. The confirmation signal may be communicated using a different network than the downloaded welcome video.

In step 296, a success message such as that illustrated above in FIG. 4 may be presented to the user. This step may also engage or communicate with the billing or STMS system that the customer is now billing. In step 298, a message may be sent to the website to release the queue.

Referring back to step 290, if the welcome video has not been sent, step 300 is performed in which the customer calls customer service and various error handling and messages may be generated to help the customer determine the source of the problem in step 302.

Referring now to FIG. 6, a method of enabling access to a service such as a broadband video service is illustrated. In step 400, the user device such as a set top box is placed into the network. This is performed by storing a MAC address into the system. This is an optional step that may be performed only if required by the system. That is, certain systems may require registration therein. As mentioned above, the network may be a wireless or a wired network.

In step 402, the user device monitors whether the user selects a start button to sign up for service. The button may be selected on the user interface generated by a set top box. The selection may take place using a remote control device or button device that is used to select an on-screen selection.

Optional confirmations may also be provided throughout the process. For example, when the user selects a start button, step 404 may generate another on-screen display that asks if the user is sure they would like to sign up for the service. If the answer to step 404 is NO, step 402 may again be executed.

In step 404, if the answer is positive, a testing of the connection may be performed in step 406. This is also an optional test since the connection may be performed by downloading a video as well.

In step 408, if the test was not successful, step 410 may provide instructions to the users to correct the problem. In step 408, if the test was successful, step 412 may generate a success indicator such as a green light or green bar on the display device.

Also, after step 412, in step 414 the user device attempts to retrieve the welcome video from the content distribution network. It should be noted that the welcome video merely represents an initial program or beginning program for this system. That is, the welcome program is merely the first program or content that is provided from the content distribution network. The welcome video may be a special video that is short and is only used for testing the download connection. However, other content may be used for the welcome video.

In step 416, if the retrieval of the welcome video is not successful, step 418 generates an error message. Instructions may also be provided to fix the error.

In step 416, if the retrieval of the welcome video is successful, step 420 provides another check to determine that the intent of the user is for subscribing to the service. If the intent is not to subscribe, step 402 may be repeated. In step 420, if it is the user's intent to sign up and pay for the service, step 422 is generated. In step 422, a confirmation signal may be communicated to the billing system from the user device after successfully receiving the welcome video.

In step 424, when the confirmation signal is received at the service provider, the controller and the STMS may add the service to the account of the particular consumer. In step 426 the service may be enabled at the user device. In step 428, a confirmation display may be provided to the user that the particular service has been added to the account. In step 430, a program may be selected from a website or from an on-screen selection. A program selection signal corresponding to the program selected may be provided to the service provider and/or the content distribution network. In step 432, the program corresponding to the selection is communicated through the network to the user device.

In step 434, the program may be stored in the memory of the user device or played as received. It is envisioned that typically the program will be stored in the memory of the user device such as in a digital video recorder. In step 436, the program may be displayed at the user device from the memory.

As may be understood by those skilled in the art, a conditional access system may be used to perform many of the operations described above. For example, the PIPs which allow pay-per-view purchases to be registered in an access card, may also be used in step 420 to register the user's intent to sign up and pay for the service. For example, the CWPs which allow the access card to generate CWs for decrypting programs and thereby register viewing, may also be used in step 422 to register viewing of the welcome video. For example the call back signal which includes content requests and viewing or pay-per-view report back, may also be used in step 422 to report back the viewing of the welcome video to the billing system from the user device. The access card or user device identification numbers may be used in this call back to identify the consumer requesting service so that in step 424 the STMS may add the service to the corresponding user account. For example the CAPs which deliver service authorizations from the service provider to the access card in the user device may also be used in step 426 to enable the service at the user device. These CAPs may be communicated over the satellite or via the Internet or via the phone modem or a wireless connection, etc. These CAPs may also use the reported access card or user device identification numbers to target the enabling signal to the specific user device requesting service.

In step 428 a PIP associated with the specific service may also be used by the user device to query service authorizations in the access card and thereby confirm to the user that the service has been added to the account. In step 430 a PIP associated with a selected program may be used to confirm that the selected program will be viewable, prior to sending the program selection signal to the service provider and/or the content distribution network. In step 432 the selected program may be downloaded from the content distribution network via satellite or broadband connection or other communication means and stored in the user device in step 434, where CWPs associated with the program may be used in step 436 to view the program.

As may be understood by those skilled in the art, variations in the above steps and in the order of the steps may achieve the same purpose. For example, in step 422 the confirmation signal to the billing system could come from the content distribution network. When the user device requests a download of the welcome video from the content distribution network, the user device may deliver an access card or user device identification number. After successful completion of the download, the content distribution network may communicate this user identification information to the billing system at the service provider, in order to enable the desired service.

For a particular account, several user devices such as a number of set top boxes for respective televisions may be used. Authorizations for each of the set top boxes may be performed in one registration process. That is, once the first set top box is registered, each of the set top boxes on the account may be authorized to receive the service. That is, each access card may be authorized by the first access card for the account. Alternatively, each set top box may be required to perform its own registration, using the successful reception of the welcome video to check and confirm that the broadband connection is correctly installed before requesting content.

As will be evident to those skilled in the art, the user device may be a portable device such as those in an automotive vehicle or other laptop computer. The content delivery may take place for a mobile device over a wireless connection. Also, callbacks may also be generated through a wireless connection.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A method of accessing a service from a user device comprising:
coupling the user device to a network;
selecting the service;
communicating a welcome video from a service provider through the network to the user device in response to selecting the service;
communicating a confirmation signal from the user device to the service provider in response to successfully receiving the welcome video; and
enabling access to the service in response to the confirmation signal.

2. A method as recited in claim 1 wherein the service comprises a video service.

3. A method as recited in claim 1 wherein coupling the user device to a network comprises coupling the user device to a broadband network.

4. A method as recited in claim 1 wherein coupling the user device to a network comprises coupling the user device to a wireless broadband network.

5. A method as recited in claim 1 wherein coupling the user device to a network comprises coupling the user device to a cellular network.

6. A method as recited in claim 1 wherein coupling the user device to a network comprises coupling the user device to a WiFi network.

7. A method as recited in claim 1 wherein coupling the user device to a network comprises coupling the user device to a WiMax network.

8. A method as recited in claim 1 wherein coupling the user device to a network comprises coupling the user device to a wired broadband network.

9. A method as recited in claim 1 wherein selecting a service comprises selecting a broadband video service.

10. A method as recited in claim 1 wherein selecting the service comprises selecting the service at a set top box.

11. A method as recited in claim 1 wherein selecting the service comprises selecting the service at a set top box using a user interface screen.

12. A method as recited in claim 1 wherein selecting the service comprises selecting the service at a satellite television set top box.

13. A method as recited in claim 1 wherein selecting the service comprises selecting the service at a mobile user device.

14. A method as recited in claim 1 wherein selecting the service comprises selecting the service from a service provider website.

15. A method as recited in claim 1 wherein communicating a confirmation signal from the user device comprises communicating the confirmation signal from the user device through the network.

16. A method as recited in claim 1 wherein communicating a confirmation signal from the user device comprises communicating the confirmation signal from the user device through a second network different than the network.

17. A method as recited in claim 1 wherein communicating a confirmation signal from the user device comprises communicating the confirmation signal from the user device through a wireless network.

18. A method as recited in claim 1 wherein communicating a confirmation signal from the user device comprises communicating the confirmation signal from the user device through a broadband network.

19. A method as recited in claim 1 wherein communicating a confirmation signal from the user device comprises communicating the confirmation signal from the user device through a cellular network.

20. A method as recited in claim 1 wherein communicating a confirmation signal from the user device comprises communicating the confirmation signal from the user device through a WiFi network.

21. A method as recited in claim 1 wherein communicating a confirmation signal from the user device comprises communicating the confirmation signal from the user device through a WiMax network.

22. A method as recited in claim 1 wherein enabling access comprises selecting a program from the service provider and communicating the program to the set top.

23. A method as recited in claim 22 further comprising storing the program in the user device.

24. A method as recited in claim 1 further comprising generating a conditional access packet from the service provider, communicating the conditional access packet through the satellite, and wherein communicating the confirmation signal is performed in response to the communication packet and successfully receiving the welcome video.

25. A method as recited in claim 1 further comprising communicating real time programming to the user device through a satellite.

26. A method of accessing a video download service from a set top box comprising:
coupling the set top box to a broadband network;
selecting the video download service from a user interface screen associated with the set top box;
generating a service selection signal in response to selecting;
communicating the service selection signal to the service provider through the broadband network;
communicating a welcome video from a service provider through the broadband network to the set top box in response to the service selection signal;
communicating a confirmation signal from the set top box to the service provider in response to successfully receiving the welcome video; and
enabling access to the service in response to the confirmation signal.

27. A method as recited in claim 26 wherein coupling the set top box to a network comprises coupling the set top box to a wireless broadband network.

28. A method as recited in claim 26 wherein coupling the set top box to a network comprises coupling the set top box to a wired broadband network.

29. A method as recited in claim 26 wherein the set top box comprises a satellite television set top box.

30. A method as recited in claim 26 wherein the set top box comprises a mobile set top box.

31. A method as recited in claim 26 wherein communicating a confirmation signal from the set top box comprises communicating the confirmation signal from the set top box through the broadband network.

32. A method as recited in claim 26 wherein communicating a confirmation signal from the set top box comprises communicating the confirmation signal from the set top box through a second network different than the broadband network.

33. A method as recited in claim 26 wherein communicating a confirmation signal from the set top box comprises communicating the confirmation signal from the set top box through a wireless broadband network.

34. A method as recited in claim 26 wherein communicating a confirmation signal from the set top box comprises communicating the confirmation signal from the set top box through a wired broadband network.

35. A method as recited in claim 26 wherein communicating a confirmation signal from the set top box comprises communicating the confirmation signal from the set top box through a cellular network.

36. A method as recited in claim 26 wherein communicating a confirmation signal from the set top box comprises communicating the confirmation signal from the set top box through a telephone network.

37. A method as recited in claim 26 wherein enabling access comprises selecting a program from the service provider and communicating the program to the set top.

38. A method as recited in claim 37 further comprising storing the program in the set top box.

39. A method as recited in claim 26 further comprising generating a conditional access packet from the service provider, communicating the conditional access packet through the satellite, and wherein communicating the confirmation signal is performed in response to the communication packet and successfully receiving the welcome video.

40. A method as recited in claim 26 further comprising communicating real time programming to the set top box through a satellite.

41. A communication system for accessing a service through a network comprising:
a user device in communication with the network, said user device selecting the service;
a service provider communicating a welcome video through the network to the user device in response to selecting the service;
said user device communicating a confirmation signal to the service provider in response to successfully receiving the welcome video; and
said service provider enabling access to the service in response to the confirmation signal.

42. A system as recited in claim 41 wherein the service comprises a video service.

43. A system as recited in claim 41 wherein the network comprises a broadband network.

44. A system as recited in claim 41 wherein the network comprises a wireless broadband network.

45. A system as recited in claim 41 wherein the network comprises a cellular network.

46. A system as recited in claim 41 wherein the network comprises a WiFi network.

47. A system as recited in claim 41 wherein the network comprises a WiMax network.

48. A system as recited in claim 41 wherein the network comprises a wired broadband network.

49. A system as recited in claim 41 wherein the service comprises a broadband video service.

50. A system as recited in claim 41 wherein the user device comprises a set top box.

51. A system as recited in claim 41 wherein the user device comprises a set top box generating a user interface screen for selecting the service.

52. A system as recited in claim 41 wherein the user device comprises a satellite television set top box.

53. A system as recited in claim 41 wherein the user device comprises a mobile user device.

54. A system as recited in claim 41 further comprising a second network different than the network, said user device communicating the confirmation signal through the second network.

55. A system as recited in claim 41 wherein the second network comprises a wireless network.

56. A system as recited in claim 41 wherein the second network comprises a broadband network.

57. A system as recited in claim 41 wherein the second network comprises a cellular network.

58. A system as recited in claim 41 wherein the second network comprises a WiFi network.

59. A system as recited in claim 41 wherein the second network comprises a WiMax network.

60. A system as recited in claim 41 wherein said service provider communicates the program to a set top box.

61. A system as recited in claim 60 wherein the user device stores the program in the user device.

62. A system as recited in claim 41 further comprising generating a conditional access packet from the service provider, communicating the conditional access packet through the satellite, and wherein communicating the confirmation signal is performed in response to the communication packet and successfully receiving the welcome video.

63. A system as recited in claim 41 further comprising a satellite, said service provider communicating real time programs to the user device through a satellite.

64. A system as recited in claim 41 wherein the user device comprises a fixed user device.

65. A system as recited in claim 41 wherein the user device comprises a mobile user device.
